(19) United States
(12) Patent Application Publication
(10) Pub. No.: US 2021/0092254 A1
(43) Pub. Date: Mar. 25, 2021

(54) ADDRESS SEARCH SYSTEM, ADDRESS SEARCH METHOD, AND PROGRAM

(71) Applicant: KONICA MINOLTA, INC., Tokyo (JP)

(72) Inventors: SHIMPEI ITAYA, Tokyo (JP); YUSUKE MIKOSHIBA, Toyokawa-shi (JP)

(73) Assignee: KONICA MINOLTA, INC., Chiyoda-ku, Tokyo (JP)

(21) Appl. No.: 16/999,737

(22) Filed: Aug. 21, 2020

(30) Foreign Application Priority Data
Sep. 24, 2019 (JP) 2019-172515

(51) Int. Cl. H04N 1/32; G10L 15/22; G10L 15/26; H04N 1/00

(52) U.S. Cl. CPC H04N 1/32096; G10L 15/22; G10L 2015/223; H04N 1/00403; H04N 1/32064; G10L 15/26

(57) ABSTRACT

An address search system includes: a hardware processor that receives, as text information including a logogram, address information as a voice recognition result transmitted from a server or a device that recognizes a voice, converts the received text information of the logogram into text information of a character of reading, also converts the converted text information of the character of reading into a plurality of pieces of text information including the logogram again, and searches for a registered address using the plurality of pieces of text information including the logogram; and a presenter that presents the address searched by the hardware processor.

### The entire disclosure of Japanese patent Application No. 2019-172515, filed on Sep. 24, 2019, is incorporated herein by reference in its entirety.

### BACKGROUND

### Technological Field

The present invention relates to an address search system, an address search method, and a program, and more particularly to a technique of searching an address by voice input.

Description of the Related art

In recent years, a voice input/output device called a smart speaker has been developed, and various kinds of operation for various devices can be made with the voice input/output device connected to the Internet when a user gives a voice instruction through the voice input/output device. For example, when the user gives a voice instruction “turn on the light” to the voice input/output device, a command of turning on is sent from the voice input/output device to a lighting device in the room where the user is present through a server in the cloud environment, and the lighting device is turned on.

Examples of voice operation using the voice input/output device include call operation using a telephone or a facsimile (hereinafter, those devices will be referred to as controlled devices). The controlled device has a built-in address book (telephone book) function, and telephone numbers and the like of destinations are registered in advance. Normally, when the user makes a call operation by, for example, a button operation, a list of registered names is displayed on the operation panel of the controlled device, and the user selects the name the user wishes to make a call from the displayed names by touch operation.

In the voice operation using the voice input/output device, for example, when voice input of “send to Mr./Ms. xx” is made, the corresponding name is searched by the function of the address book, and the controlled device performs a process of transmission to the telephone number that has found.

JP 2010-147624 A discloses an exemplary technique of searching for a destination by voice input.

Meanwhile, in the case of making voice input using the voice input/output device called a smart speaker, the input voice information is once transmitted to a server, and the artificial intelligence (AI) function is used in the server to convert the voice of reading into text including proper Chinese characters. Then, the text information converted in the server is transmitted to the controlled device.

For example, when voice input of “send to Mr./Ms. Sasaki” is made, the server that has received the voice information generates text information of Chinese characters “SASAKI” that are the most typical text for the reading “Sasaki”, and a command of facsimile transmission, which are transmitted to the controlled device.

The controlled device that has received the text information and the command determines whether there is a registration of a name that matches the text information of “SASAKI” in the registered address book.

Here, there is no problem if the name registered in the address book is “SASAKI” that matches the received text information, but in reality, there are various Chinese characters for the reading “Sasaki”, such as “SASAki (Chinese characters different from “SASAKI”)”, “sasaki (Chinese characters different from “SASAKI” and “SASAki”)”, and “SaSaKi (Chinese characters different from “SASAKI”, “SASAki”, and “sasaki”)”.

Therefore, there may be a case where the controlled device that has received the text information “SASAKI” has an address registration of different Chinese characters such as “SASAki”, but does not have an address registration of “SASAKI”. In such a case, the controlled device determines that there is no registration of the corresponding address, and does not execute the command of transmission by the voice input.

As described above, in a case where a name of Chinese characters different from a name of typical Chinese characters is registered in the address book, the registered name cannot be found by voice input using the smart speaker.

### SUMMARY

It is an object of the present invention to provide an address search system, an address search method, and a program capable of accurately and reliably searching an address registered with logograms such as Chinese characters by voice input.

To achieve the abovementioned object, according to an aspect of the present invention, an address search system reflecting one aspect of the present invention comprises: a hardware processor that receives, as text information including a logogram, address information as a voice recognition result transmitted from a server or a device that recognizes a voice, converts the received text information of the logogram into text information of a character of reading, also converts the converted text information of the character of reading into a plurality of pieces of text information including the logogram again, and searches for a registered address using the plurality of pieces of text information including the logogram; and a presenter that presents the address searched by the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of a system according to an embodiment of the present invention;

FIG. 2 is a block diagram illustrating an exemplary configuration of each device included in a system according to an embodiment of the present invention;

FIG. 3 is a flowchart illustrating an exemplary process in a device management server according to an embodiment of the present invention; and

FIG. 4 is a diagram illustrating an outline of a flow of an address search according to an embodiment of the present invention.

### DETAILED DESCRIPTION OF EMBODIMENTS

Hereinafter, one or more embodiments of the present invention (hereinafter referred to as “the present embodiment”) will be described with reference to the drawings. However, the scope of the invention is not limited to the disclosed embodiments.

### Configuration of Image Processing System

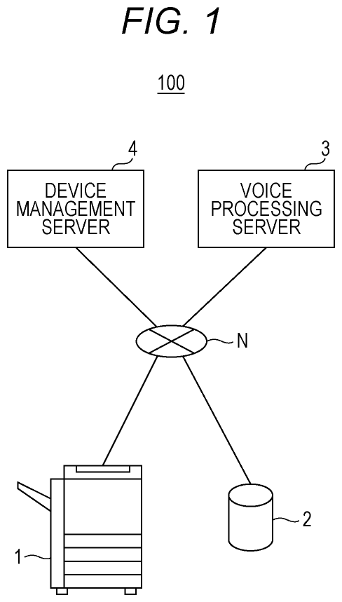

First, a system configuration of the present embodiment will be described with reference to FIG. 1. FIG. 1 is a schematic configuration diagram of an image processing system 100 to which the present embodiment is applied.

The image processing system 100 illustrated in FIG. 1 includes an image forming apparatus 1, a voice input/output device 2, a voice processing server 3, and a device management server 4. The image forming apparatus 1, the voice input/output device 2, the voice processing server 3, and the device management server 4 illustrated in FIG. 1 are connected to a network N including, for example, a public switched telephone network, or an internet protocol (IP) network.

The image forming apparatus 1 includes, for example, a multi-functional peripheral (MFP) having a copy function, a printer function, a scanner function, a facsimile function, and the like. The image forming apparatus 1 forms an image on a sheet (exemplary recording material) on the basis of image data transmitted from a printer controller (not illustrated) or the like, and outputs the sheet on which the image is formed as a printed material. Furthermore, the image forming apparatus 1 is capable of transmitting, on the basis of the facsimile function, the image data to another party by telephone line, and has data of an address book that is a list of destinations.

The voice input/output device 2 is composed of, for example, a smart speaker, and includes a microphone and a speaker (not illustrated). The voice input/output device 2 converts an operation instruction by a voice collected by a microphone, which is, for example, a voice uttered by a user, into voice data (hereinafter also referred to as “voice information”), and transmits the voice information to the voice processing server 3. Furthermore, the voice input/output device 2 receives the voice information transmitted from the voice processing server 3, and outputs a voice from a speaker. With the output of the voice from the speaker of the voice input/output device 2, a process of presenting, to the user, the voice of a response that is a result of the voice instruction uttered by the user is performed. Therefore, the voice input/output device 2 also functions as a response voice presenter.

The voice processing server 3 is provided, for example, on the cloud (not illustrated), and its function is provided as a cloud application service. The voice processing server 3 performs a voice analysis process on the voice information transmitted (input) from the voice input/output device 2. Then, the voice processing server 3 transmits information such as a job instruction or text information, which is a result of the voice analysis process, to the device management server 4. For example, when the voice processing server 3 determines a voice for instructing a job in the voice analysis process, it transmits the job instruction to the device management server 4. Furthermore, when a name is determined in the voice analysis process, text information of the name determined from the voice is transmitted to the device management server 4.

In a similar manner to the voice processing server 3, the device management server 4 is a server that is provided on the cloud and remotely manages the image forming apparatus 1.

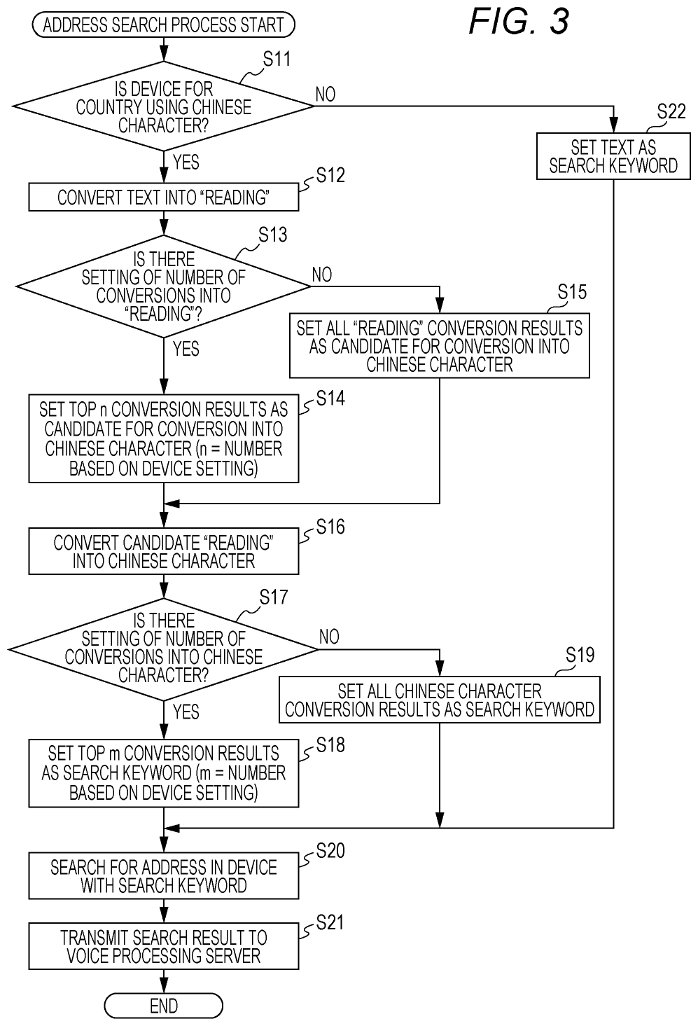

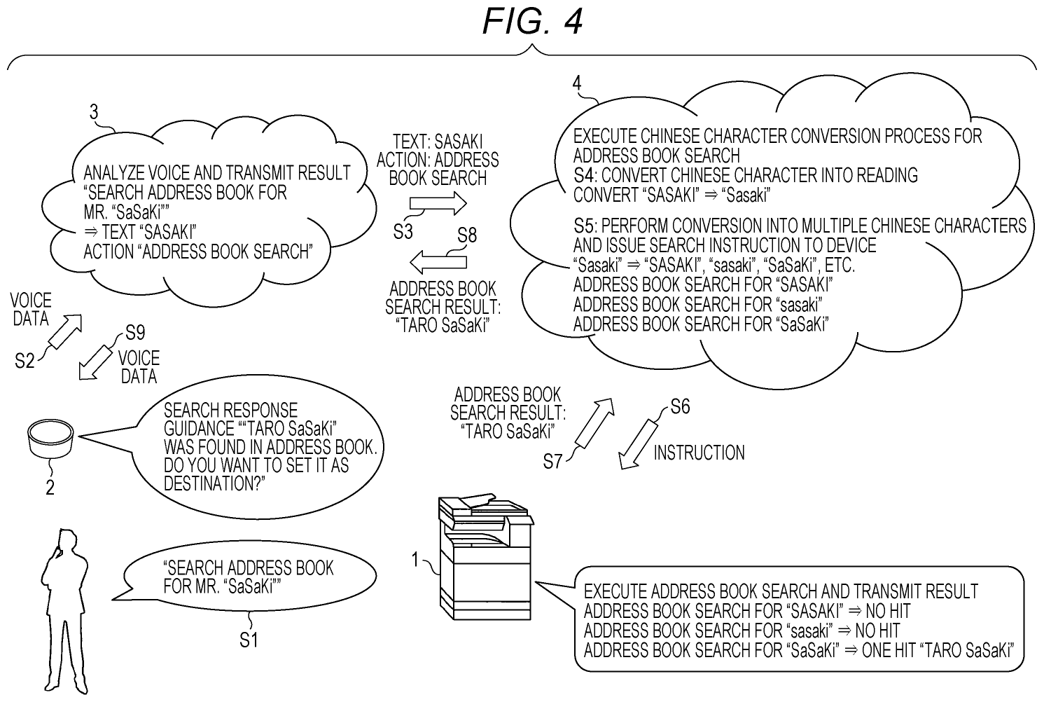

The device management server 4 generates a command (instruction) for controlling the image forming apparatus 1 on the basis of the text information and/or the job instruction received from the voice processing server 3, and transmits the generated command to the image forming apparatus 1. Furthermore, when the device management server 4 receives the text information related to an address from the voice processing server 3, it converts the text information, and transmits the converted text information to the image forming apparatus 1. Note that details of the conversion process of the text information will be described later with reference to FIGS. 3 and 4.

Note that the voice processing server 3 and the device management server 4 can also transmit response voice information and notification voice information to the voice input/output device 2. The response voice information from the device management server 4 is transmitted to the voice input/output device 2 via the voice processing server 3.

Here, the response voice information indicates a voice for making notification on response information to an operation instruction (voice operation) made by the user's utterance through the voice input/output device 2, and the notification voice information indicates a voice for making notification on notification information from the image forming apparatus 1 such as occurrence of an error and completion of a job. Examples of a command to the image forming apparatus 1 include a job setting instruction such as printing, copying, scanning, and facsimile, and a job start instruction.

Note that, although an exemplary case where the voice processing server 3 and the device management server 4 are provided on the cloud has been described in the present embodiment, the present invention is not limited thereto. For example, one or both of the voice processing server 3 and the device management server 4 may be provided in the image forming apparatus 1. Furthermore, the voice processing server 3 and the device management server 4 may be configured as one server.

### Configuration of Each Device

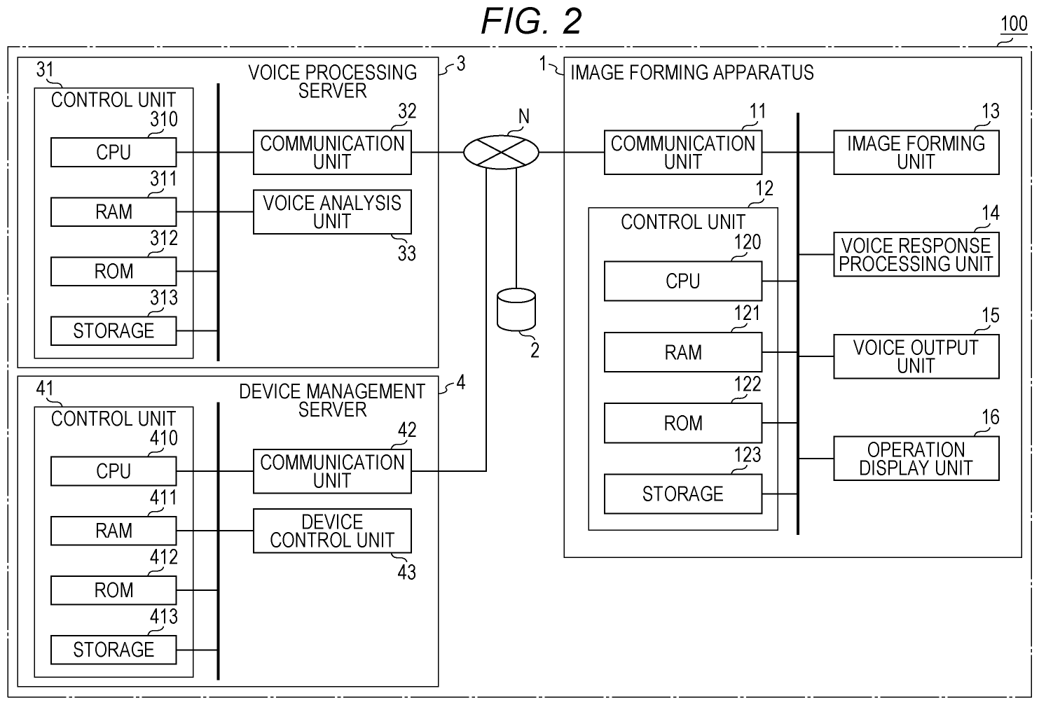

Next, exemplary configurations of the image forming apparatus 1, the voice input/output device 2, the voice processing server 3, and the device management server 4 included in the image processing system 100 will be described with reference to FIG. 2.

### Configuration of Image Forming Apparatus

First, a configuration of the image forming apparatus 1 will be described. As illustrated in FIG. 2, the image forming apparatus 1 includes a communication unit 11, a control unit 12, an image forming unit 13, a voice response processing unit 14, a voice output unit 15, and an operation display unit 16.

The communication unit 11 controls various data transmission/reception operations performed with the voice processing server 3 connected via the network N.

The control unit 12 includes a central processing unit (CPU) 120, a random access memory (RAM) 121, a read-only memory (ROM) 122, and a storage 123.

The CPU 120 reads various processing programs stored in the ROM 122, such as a system program for controlling the entire system (entire image forming apparatus 1) and an image forming processing program, loads the programs in the RAM 121, and controls operation of each unit of the image forming apparatus 1 according to the loaded programs.

For example, the CPU 120 controls the image forming unit 13 to execute an image forming process associated with the command input from the voice processing server 3.

The RAM 121 forms a work area for temporarily storing various programs to be executed by the CPU 120 and data related to those programs, and the work area of the RAM 121 stores job queues, various operation settings, and the like.

The ROM 122 includes, for example, a nonvolatile memory such as a semiconductor memory, and the ROM 122 stores, for example, a system program supporting the image forming apparatus 1, a voice response processing program, and an image forming processing program executable on the system program. Those programs are stored in the form of computer-readable program codes, and the CPU 120 sequentially executes the operation according to the program codes.

The storage 123 includes, for example, a hard disk drive (HDD) and a solid state drive (SSD), and the storage 123 stores, for example, various setting data related to the image forming apparatus 1, and the voice data (voice response information, voice notification information, etc.) corresponding to various instructions transmitted from the CPU 120 to the voice response processing unit 14.

Note that the control unit 12 has a function of an address book that is a destination list of the facsimile function. That is, the ROM 122 stores a program that implements the address book function, and the storage 123 stores names, telephone numbers, and the like that are data of the address book. The CPU 120 reads out the address book program from the ROM 122 and executes it, whereby the operation display unit 16 displays the address book and the destination can be selected. In the present embodiment, the address book can register names with various characters such as Chinese characters (ideographic characters), “hiragana” characters, “katakana” characters, alphabets, and numbers.

Furthermore, the control unit 12 has a function as an address search unit that executes an address search process for searching an address that matches an input search keyword from the addresses stored as the address book.

The image forming unit 13 forms an image on a sheet on the basis of image data transmitted from a printer controller (not illustrated) or the like, and outputs the sheet on which the image is formed as a printed material. The image forming unit 13 includes a charging device, a photosensitive drum, an exposure device, a transfer belt, and a fixing device, which are not illustrated.

First, the image forming unit 13 causes the exposure device to irradiate the photosensitive drum charged by the charging device with light corresponding to the image, thereby forming an electrostatic latent image on the circumference of the photosensitive drum. Subsequently, the image forming unit 13 supplies toner from a developing device to the photoconductor to attach the toner onto the charged electrostatic latent image, thereby developing the toner image. Subsequently, the image forming unit 13 primarily transfers the toner image onto the transfer belt, secondarily transfers the toner image transferred onto the transfer belt onto a paper sheet, and further fixes, using the fixing device, the transferred toner image onto the paper.

Note that, although an exemplary case where the image forming unit 13 forms an image using the electrographic method has been described in the present embodiment, the present invention is not limited thereto. The image processing system and the image forming apparatus according to the present invention may use an image forming unit that forms an image using another method such as the inkjet recording method.

The voice response processing unit 14 extracts, from the storage 123 or the like, voice information corresponding to the instruction input from the CPU 120 to generate the voice information, and outputs it to the voice output unit 15. The instruction from the CPU 120 is given when, for example, there is a setting error such as prohibition in the setting based on the operation instruction by voice, or an error occurs during operation.

The voice output unit 15 includes, for example, a speaker, and reproduces the voice information input from the voice response processing unit 14 to output it as voice.

The operation display unit 16 is configured as, for example, a touch panel in which an operation screen display unit including a liquid crystal display (LCD), an organic electroluminescence (EL), and the like and an operation input unit including a touch sensor and the like are integrally formed.

Note that, although an exemplary case where the display and the operation input unit are integrally formed as the operation display unit 16 has been described in the present embodiment, the present invention is not limited thereto. The display and the operation input unit including a keyboard, a mouse, and the like may be separately provided. Alternatively, the operation input unit including a keyboard, a mouse, and the like may be provided in addition to the operation display unit 16 configured as a touch panel.

### Configuration of Voice Processing Server

Next, a configuration of the voice processing server 3 will be described also with reference to FIG. 2. As illustrated in FIG. 2, the voice processing server 3 includes a control unit 31, a communication unit 32, and a voice analysis unit 33.

The control unit 31 includes a CPU 310, a RAM 311, a ROM 312, and a storage 313.

The CPU 310 reads various processing programs stored in the ROM 312, such as a system program and a voice processing program, loads the programs in the RAM 311, and controls operation of each unit of the voice processing server 3 according to the loaded programs.

For example, when the voice input/output device 2 transmits the voice information, the CPU 310 performs control to transmit various instructions corresponding to the voice information and the text information determined from the voice to the device management server 4 via the communication unit 32. Furthermore, for example, when the device management server 4 transmits response information, the CPU 310 performs control to transmit the voice information corresponding to the response information to the voice input/output device 2 via the communication unit 32.

In the RAM 311, a work area for temporarily storing various programs to be executed by the CPU 310 and data related to those programs is formed.

The ROM 312 includes, for example, a nonvolatile memory such as a semiconductor memory, and the ROM 312 stores, for example, a system program supporting the voice processing server 3, and a voice processing program executable on the system program. Those programs are stored in the form of computer-readable program codes, and the CPU 310 sequentially executes the operation according to the program codes.

The storage 313 includes, for example, an HDD and an SSD, and the storage 313 stores, for example, various setting data related to the voice processing server 3, and instructions related to image processing jobs associated with a result of voice analysis performed by the voice analysis unit 33.

The communication unit 32 controls various data transmission/reception operations performed between the voice input/output device 2 and the device management server 4 connected via the network N.

The voice analysis unit 33 analyzes the voice information transmitted from the voice input/output device 2, reads the text information, job instruction, and the like corresponding to the result of the voice analysis from the storage 313, and outputs them to the control unit 31.

When the voice analysis unit 33 analyzes the voice information and detects a voice that instructs job execution of the image forming apparatus 1, the control unit 31 transmits the job instruction from the communication unit 32 to the device management server 4.

Furthermore, when the voice analysis unit 33 analyzes the voice information and detects a voice indicating a name, the control unit 31 transmits text information indicating the name from the communication unit 32 to the device management server 4.

Note that, although the voice analysis unit 33 is configured as a processing unit different from the control unit 41 in FIG. 2, the voice analysis unit 33 can be configured by executing a program stored in the ROM 312, for example.

### Configuration of Device Management Server

Next, a configuration of the device management server 4 will be described also with reference to FIG. 2.

As illustrated in FIG. 2, the device management server 4 includes a control unit 41, a communication unit 42, and a device control unit 43.

The control unit 41 includes a CPU 410, a RAM 411, a ROM 412, and a storage 413.

The CPU 410 reads various processing programs stored in the ROM 412, such as a system program and a voice processing program, loads the programs in the RAM 411, and controls operation of each unit of the device management server 4 according to the loaded programs.

For example, when the voice processing server 3 transmits a job instruction, the CPU 410 performs control to transmit a command of the image forming apparatus 1 corresponding to the job to the image forming apparatus 1 via the communication unit 42. Note that the command of the image forming apparatus 1 is a command obtained from the device control unit 43. The device control unit 43 stores information associated with the configuration of the image forming apparatus 1, and the CPU 410 determines, on the basis of the information stored in the device control unit 43, what command the image forming apparatus 1 accepts, for example.

The CPU 410 also functions as a text information converter. That is, when the voice processing server 3 transmits text information of a name, the CPU 410 performs control to carry out a conversion process on the received text information and then transmit one or more pieces of text information obtained by the conversion to the image forming apparatus 1 via the communication unit 42. The ROM 412 also stores a program for converting the text information. Note that specific examples of the conversion process of the text information will be described later.

Furthermore, for example, when the image forming apparatus 1 transmits response information, the CPU 410 performs control to transmit the response information to the voice processing server 3 via the communication unit 42.

In the RAM 411, a work area for temporarily storing various programs to be executed by the CPU 410 and data related to those programs is formed.

The ROM 412 includes, for example, a nonvolatile memory such as a semiconductor memory, and the ROM 412 stores, for example, a system program supporting the device management server 4, and a device control program executable on the system program. Those programs are stored in the form of computer-readable program codes, and the CPU 410 sequentially executes the operation according to the program codes.

The storage 413 includes, for example, an HDD and an SSD, and the storage 413 stores various kinds of setting data related to the device management server 4, and information required for a conversion process to be performed on the text information.

The communication unit 42 controls various data transmission/reception operations performed among the image forming apparatus 1, the voice input/output device 2, and the voice processing server 3, which are connected via the network N.

The device control unit 43 stores information associated with a configuration and functions of the image forming apparatus 1 connected via the network N, and provides the control unit 41 with information required to control the image forming apparatus 1.

### Process for Voice Instruction

Next, a process at the time when the image processing system 100 according to the present embodiment issues a voice instruction will be described with reference to the flowchart of FIG. 3.

The example illustrated in FIG. 3 shows a case where a voice input to the voice input/output device 2 indicates a name registered in the address book of the image forming apparatus 1, and shows a process flow of searching the address book for the name.

First, a voice input to the voice input/output device 2 is determined to be voice information of a name through a voice analysis process performed in the voice processing server 3. Subsequently, the voice processing server 3 converts the voice information into text information, and the text information is transmitted to the device management server 4. The text information to be converted by the voice processing server 3 is text information of characters that seem to be most appropriate from the voice, and the characters here include Chinese characters.

Explaining according to the flowchart of FIG. 3, the control unit 41 of the device management server 4 that has received the text information from the voice processing server 3 determines whether a country or region where the image forming apparatus 1 is used is a country or region where Chinese characters that are ideographic characters are used (step S11). If it is determined in step S11 that the country or region uses Chinese characters (YES in step S11), the control unit 41 of the device management server 4 converts the received text including Chinese characters into text for reading (step S12). When converting the text into text for reading, the device management server 4 uses, for example, dictionary data stored in the storage 413. Alternatively, the device management server 4 may use dictionary data prepared in an external server via the network N.

Then, as a setting for performing the conversion process, the control unit 41 determines whether there is a setting of the upper limit of the number of conversions into text for reading (step S13).

If it is determined in step S13 that the upper limit of the number of conversions into text for reading is limited to n (n is an optional integer) (YES in step S13), the control unit 41 sets the top n pieces of text in the text obtained by the conversion in step S12 as candidates for reading from Chinese characters (step S14). Here, a candidate having a high possibility of converting a Chinese character into text for reading is set as a high-ranked candidate. That is, those that are more likely to be converted into text for reading are higher ranked, and those that are less likely to be converted are lower ranked. For example, dictionary data is used for the determination of higher and lower ranking.

If it is determined in step S13 that there is no limit of the number of conversions into text for reading (NO in step S13), the control unit 41 sets all the text conversion results converted in step S12 as candidates for conversion from Chinese characters into text for reading (step S15).

Next, the control unit 41 converts the candidate text for reading obtained in step S14 or S15 into text of names including Chinese characters (step S16).

Here, as a setting for performing the conversion process, the control unit 41 determines whether there is a setting of the upper limit of the number of conversions into Chinese characters (step S17).

If it is determined in step S17 that the upper limit of the number of conversions into Chinese characters is limited to m (m is an optional integer) (YES in step S17), the control unit 41 sets the top m results of conversion into Chinese characters in the text of names in Chinese characters obtained by the conversion in step S16 as search keywords (step S18). In this step as well, using dictionary data or the like, those that are more likely to be converted into Chinese characters from the text for reading are higher ranked, and those that are less likely to be converted are lower ranked.

Furthermore, if it is determined in step S17 that there is no limit of the number of conversions into Chinese characters (NO in step S17), the control unit 41 sets all the results of text conversion into Chinese characters converted in step S16 as search keywords (step S19).

Next, the control unit 41 transmits the text information of the search keyword obtained in step S14 or S15 from the communication unit 42 to the image forming apparatus 1. Under the control of the control unit 12, the image forming apparatus 1 that has received the text information of the search keyword searches for a name registered in the address book using the received text information as a search keyword (step S20).

The text information of the name of the search result found by the search of the address book is transmitted from the image forming apparatus 1 to the voice processing server 3 via the device management server 4 (step S21).

The voice processing server 3 converts the received text information of the name of the search result into voice information, transmits the converted voice information to the voice input/output device 2, and outputs a voice from the speaker in the voice input/output device 2. The output of the response voice from the voice input/output device 2 is performed as a voice notification process of the search result of the address book.

If it is determined in step S11 to be a country or region where Chinese characters are not used (NO in step S11), the control unit 41 of the device management server 4 sets the received text as it is as a search keyword (step S22). When the search keyword is set in step S22, the process proceeds to step S20, and the control unit 41 transmits the search keyword from the communication unit 42 to the image forming apparatus 1.

FIG. 4 illustrates a specific example in which the address search explained with reference to the flowchart of FIG. 3 is executed in the image processing system 100 according to the present embodiment.

First, a user in the vicinity of the voice input/output device 2 gives a voice instruction “search the address book for Mr. SaSaKi” (step S1). At this time, the voice information (search the address book for Mr. Sasaki) input from the voice input/output device 2 is transmitted to the voice processing server 3 (step S2).

The voice processing server 3 obtains, from the received voice information of “search the address book for Mr. Sasaki”, the text information of “SASAKI” in Chinese characters indicating the typical name of “Sasaki” and the instruction of the “address book search” that is the instructed action. The text information of “SASAKI” and the action information of the “address book search” are transmitted to the device management server 4 (step S3).

The device management server 4 that has received the text information of “SASAKI” and the action information of the “address book search” executes a Chinese character conversion process for the address book search (step S4).

That is, the device management server 4 first converts Chinese characters into text for reading

Here, “SASAKI”, which is the text information of Chinese characters, is converted into text information “Sasaki” in Hiragana (or Katakana) with reference to the dictionary data. Note that, in a case where there is a plurality of candidates for conversion from Chinese characters into text for reading, it is converted into the plurality of pieces of text information of the text for reading. However, as described in step S14 of FIG. 3, if the upper limit n is set for the number of candidates, the text information is limited to the top n pieces.

Next, the device management server 4 converts the text for reading into Chinese characters (step S5).

Here, the device management server 4 refers to the dictionary data to convert the text information of “Sasaki” into a plurality of pieces of Chinese character text information on the same reading “SASAKI”, “sasaki (Chinese characters different from “SASAKI”)”, “SaSaKi (Chinese characters different from “SASAKI” and “sasaki”)”, and so on. In this step as well, as described in step S18 of FIG. 3, if the upper limit m is set for the number of candidates, the text information is limited to the top m pieces. In this example, the device management server 4 sets the upper limit m to three, for example, and sets the top three pieces of Chinese character text information “SASAKI”, “sasaki”, and “SaSaKi” as search keywords.

The text information of the three search keywords “SASAKI”, “sasaki”, and “SaSaKi” obtained by the device management server 4 is transmitted to the image forming apparatus 1 together with the action information of the “address book search” (step S6).

The image forming apparatus 1 that has received the information searches the data registered as the address book, and searches for the three search keywords “SASAKI”, “sasaki”, and “SaSaKi”.

Here, it is assumed that, as a result of the search, there is no name registration of the search keyword “SASAKI”, there is also no name registration of the search keyword “sasaki”, and there is one registered address including the name “SaSaKi”. That is, it is assumed that there is one address registration with the name “Taro SaSaKi”.

At this time, the image forming apparatus 1 transmits, as an address book search result, the searched text information of “Taro SaSaKi” to the voice processing server 3 via the device management server 4 (steps S7 and S8).

The voice processing server 3 that has received the address book search result “Taro SaSaKi” transmits, to the voice input/output device 2, the voice information indicating that the address book search result is “Taro SaSaKi”, and the voice input/output device 2 outputs the transmitted voice from the speaker (step S9).

For example, the voice input/output device 2 outputs “Taro SaSaKi” was found in the address book. Do you want to set it as a destination?”, as a voice of the search result guidance.

As described above, according to the present embodiment, the address search in the image forming apparatus 1 can be carried out highly accurately in the case where a voice instruction is made through the voice input/output device 2 called a smart speaker.

That is, for example, in the exemplary case described in FIG. 4, if the device management server 4 does not execute the conversion process according to the present embodiment when “Sasaki” is input by voice, only “SASAKI”, which is typical Chinese characters for “Sasaki”, is searched, and addresses registered with other Chinese characters having the same reading are not searched.

On the other hand, according to the present embodiment, the device management server 4 once converts it into text for reading and then converts it into a plurality of candidates, whereby addresses registered with other Chinese characters having the same reading can be searched correctly, and the search accuracy is improved.

Note that the process according to the present embodiment is effective in the case of using ideographic characters such as Chinese characters. Therefore, the process according to the present embodiment does not need to be executed when the image forming apparatus 1 is used in a country or region other than the country or region where Chinese characters (ideographic characters) are used. Accordingly, as described in step S11 in the flowchart of FIG. 3, the process according to the present embodiment is executed after confirming the country or region where the image forming apparatus 1 is used, whereby the load on the device management server 4 can be reduced when the process is unnecessary.

Furthermore, as described in step S18 in the flowchart of FIG. 3, the upper limit number of candidates can be set when the text for reading is converted into Chinese characters to obtain search keywords, whereby the load related to the conversion process in the device management server 4 and the search in the image forming apparatus 1 can be reduced.

Moreover, as described in steps S13, S14, and S15 in the flowchart of FIG. 3, also at the time of converting the text in Chinese characters into the text for reading, candidates can be properly selected when a plurality of readings exists for one Chinese character, whereby the search accuracy is improved from this point of view as well.

For example, the name “WATANABE” can be read as “Watanabe”, “Watabe”, “Watanobe”, and the like, and those multiple readings are converted into Chinese characters to increase the candidates for the address book search, whereby the search accuracy can be further improved.

At the time of converting the text in Chinese characters into the text for reading as well, as described in step S14 in the flowchart of FIG. 3, the upper limit number of candidates can be set, whereby the load on the device management server 4 during the conversion process can be reduced.

Note that it is sufficient if the upper limit number m for converting the text for reading into Chinese characters in step S18 and the upper limit number n in step S14 are determined on the system side and registered in the device management server 4 at the time of configuring the image processing system 100, for example. Alternatively, the user of the image forming apparatus 1 may set those upper limit numbers. Alternatively, the search keyword may be limited during the printing operation of the image forming apparatus 1, and switching may be performed depending on the operation status of the image forming apparatus 1.

### Variations

Note that the present invention is not limited to the embodiment described above, and various other application examples and modifications can be made without departing from the gist of the present invention described in the appended claims

For example, although an exemplary case where a smart speaker is used as the voice input/output device 2 has been described in the embodiment described above, the present invention is not limited thereto. A mobile terminal device carried by a user, such as a mobile phone terminal and a smartphone, may be used as the voice input/output device 2.

Furthermore, although the voice processing server 3 and the device management server 4 are provided in the configuration illustrated in FIGS. 1 and 2, those servers 3 and 4 may be configured as one server.

Alternatively, text information of Chinese characters (ideographic characters) obtained by the voice processing server 3 may be transmitted to the image forming apparatus 1, and the Chinese characters may be converted into text for reading and the text for reading may be converted into a plurality of Chinese character search keywords in the image forming apparatus 1.

In a case where conversion is carried out in the image forming apparatus 1, the image forming apparatus 1 may include a microphone and a voice recognition processing unit so that the image forming apparatus 1 can input a voice from the user, and the voice input/output device 2 and the servers 3 and 4 may be omitted.

Furthermore, even in the case of the system configuration including the voice input/output device 2, the image forming apparatus 1 itself may output a response voice. Alternatively, the operation display unit 16 included in the image forming apparatus 1 may display a search result to present the result to the user.

Furthermore, although the image forming apparatus 1 storing address book data performs keyword search of the address book, the device management server 4 (or the voice processing server 3) may execute the keyword search process while communicating with the image forming apparatus 1. Alternatively, the device management server 4 or the voice processing server 3 may read and store the address book information registered in the image forming apparatus 1, and the keyword search may be carried out in the device management server 4 or the voice processing server 3.

Furthermore, although the system including the image forming apparatus 1 has been described in the embodiment described above, the present invention can be applied to other devices and systems storing address book data, such as a telephone.

Furthermore, the processes in the servers 3 and 4 and the image forming apparatus 1 described in each embodiment described above may be configured as a program for executing the processing procedure to be installed in an existing server or image forming apparatus, whereby the existing server or image forming apparatus may be configured as the image processing system 100 according to the present invention. The program can be stored in a recording medium such as a semiconductor memory and various disks. Alternatively, the program may be distributed to the server or the image forming apparatus via a transmission medium such as the Internet.

Although embodiments of the present invention have been described and illustrated in detail, the disclosed embodiments are made for purposes of illustration and example only and not limitation. The scope of the present invention should be interpreted by terms of the appended claims

What is claimed is:

1. An address search system comprising:
a hardware processor that receives, as text information including a logogram, address information as a voice recognition result transmitted from a server or a device that recognizes a voice, converts the received text information of the logogram into text information of a character of reading, also converts the converted text information of the character of reading into a plurality of pieces of text information including the logogram again, and searches for a registered address using the plurality of pieces of text information including the logogram; and
a presenter that presents the address searched by the hardware processor.

2. The address search system according to claim 1, wherein
an upper limit of a number of candidates is set when the hardware processor converts the text information of the character of reading into the plurality of pieces of text information including the logogram.

3. The address search system according to claim 1, wherein
when the hardware processor converts the received text information of the logogram into the text information of the character of reading, a plurality of conversion patterns is used for the conversion into the text information of the character of reading

4. The address search system according to claim 3, wherein
an upper limit of a number of candidates is set when the hardware processor converts the text information of the logogram into the plurality of pieces of the text information of the character of reading

5. The address search system according to claim 1, wherein
the logogram includes a Chinese character, and
the hardware processor executes the conversion when a region or a language that uses the system is a region or a language that uses Chinese characters.

6. An address search method comprising:
receiving, as text information including a logogram, address information as a voice recognition result, converting the received text information of the logogram into text information of a character of reading, and converting the converted text information of the character of reading into a plurality of pieces of text information including the logogram again;
searching for a registered address using the plurality of pieces of text information including the logogram converted in the conversion process; and
presenting the address searched in the address search process.

7. A non-transitory recording medium storing a computer readable program causing a computer to perform an address search comprising:
receiving, as text information including a logogram, address information as a voice recognition result;
converting the received text information of the logogram into text information of a character of reading and also converting the converted text information of the character of reading into a plurality of pieces of text information including the logogram again;
searching for a registered address using the plurality of pieces of text information including the logogram having been converted; and
presenting the address having been searched.
